(19) United States
(12) Patent Application Publication
(10) Pub. No.: US 2015/0251894 A1
(43) Pub. Date: Sep. 10, 2015

(54) Transportable Device for Automatically Filling Water Buckets, Troughs and Containers

(71) Applicants: Julie Barbara Lake, S. Hamilton, MA (US); Elizabeth P. McKnight, White Hall, MD (US)

(72) Inventors: Julie Barbara Lake, S. Hamilton, MA (US); Elizabeth P. McKnight, White Hall, MD (US)

(21) Appl. No.: 14/544,827

(22) Filed: Feb. 24, 2015

Related U.S. Application Data
(60) Provisional application No. 61/966,905, filed on Mar. 6, 2014.

(51) Int. Cl. B67D 7/36

(52) U.S. Cl. CPC B67D 7/362

(57) ABSTRACT

A transportable device used to fill one or more water buckets, troughs or other containers, for primary use in livestock barns and feeding areas with minimal attention from the livestock handlers.

### CROSS REFERENCE TO RELATED APPLICATIONS

This application claims the benefit of provisional patent application Ser. No. 61/966,905, filed 2014 Mar. 6 by the present inventors.

### BACKGROUND

The customary practice of filling drinking water buckets, water troughs and other water containers (together referenced in this patent application as “buckets”), such as in horse and livestock barns using a garden-type water hose is time consuming, frustrating and stressful. Barn workers and others often will devise various ways of attaching the hose to the bucket so that other tasks can be attended to while the bucket is filling. Invariably, the hose will fall out of the bucket, or the bucket will overflow because the owner or worker's attention is focused elsewhere, wasting water and time.

Devices already exist which attach permanently to a water trough or tank for the purpose of filling and maintaining a level of water. These devices are in use in the watering of livestock but are designed and intended to be left permanently installed on the trough or tank. Although it would be possible to attach one of these existing devices to a water bucket or trough, the process of attaching it and removing it for use on another bucket or trough would be extremely cumbersome and time consuming, offering little or no advantage over the customary practice of using a hand-held hose.

### SUMMARY

The embodiment of the transportable device allows for filling one or more containers with a liquid from a single source to a predetermined level. More specifically, it is intended for use in filling multiple water buckets and/or troughs in livestock stables/feeding areas, using a single hose. The transportable device fills buckets to a predetermined level, shutting off the water supply automatically without the attention of an individual, leaving the individual free to attend to other tasks. Because the device is portable, it can then be moved to the next bucket and subsequent buckets and the process repeated. To make the transfer from bucket to bucket easy, the device is designed to have a simple one-handed arrangement for attaching it to and removing it from the various buckets.

### Drawings

### Figures

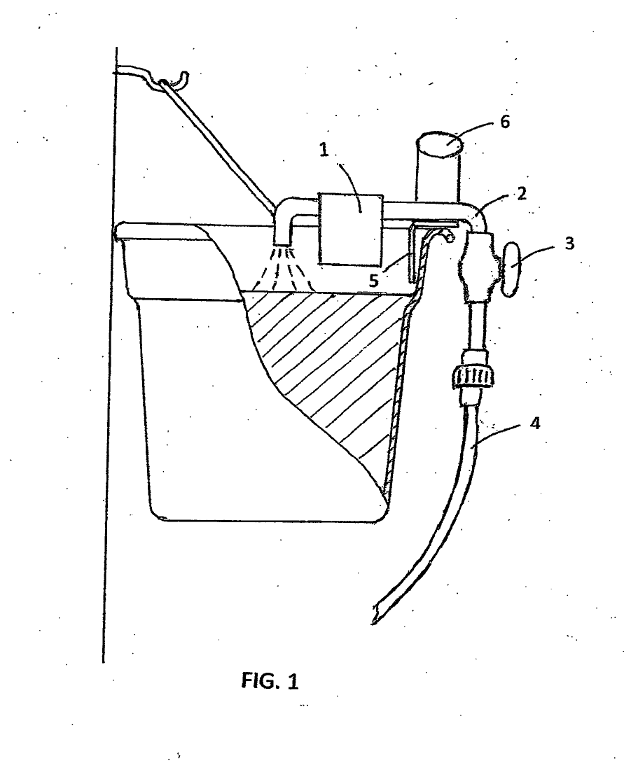

FIG. 1 shows a side view of the device mounted on a barn bucket, as an example, with part of the bucket cut away. The device itself comprises a float valve (1) connected by a pipe (2) to a shutoff valve (3) which, in turn, is connected to the water supply hose (4). A bracket (5) allows the device to rest firmly on the rim of the bucket. A handle (6) is provided to carry the device between buckets.

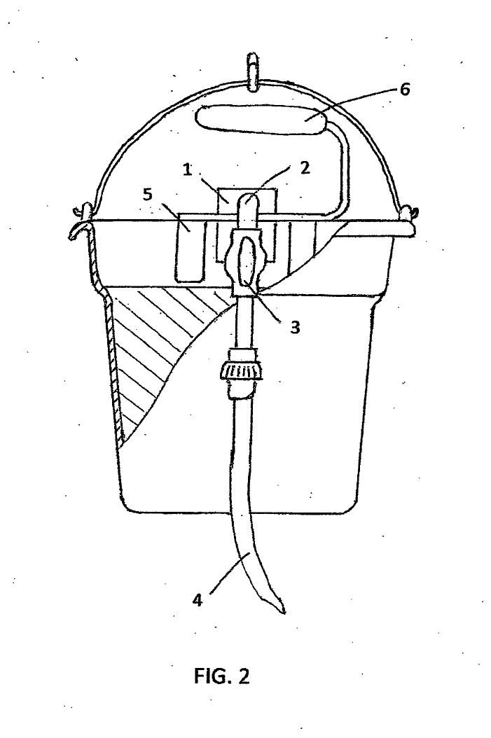

FIG. 2 shows the front view with part of the bucket cut away to reveal the float valve location.

### DETAILED DESCRIPTION

### FIGS. 1 AND 2

The embodiment of the transportable device incorporates a liquid float valve for filling water buckets. The float valve itself is of a type readily available on the market and described in the literature, and as such is not specifically a part of this device except for as a component and part of its overall function. The embodiment of the transportable device for filling water buckets and troughs allows for the positioning of a float valve within a container such as a bucket. As such, the flow of water into the container is stopped when a predetermined water level is reached. Important features of the device are that it remains firmly in place during the filling process, so that it can be left unattended, and further that it can be easily removed and transported to another bucket for filling.

In the example shown in the diagrams, the device is designed with a bracket which simply hooks over the rim of the bucket, using the weight of the water supply hose to hold the device in place, the bucket being elevated above the ground at a height comfortable for animals to drink from. The mounting bracket is made sufficiently wide to stabilize the device from tilting sideways. Other means of attaching the device, such as a spring clamp, could also be used. A handle is incorporated into the bracket to facilitate transporting the device to other locations.

Operation of the device is simple. With reference to the drawing, the device is first attached to a water supply hose (4) of sufficient length to reach all of the buckets to be filled. The shutoff valve (3) is closed and the water supply hose is turned on. The device is then attached to the first bucket by hooking the bracket (5) over the rim of the bucket. The valve (3) is opened allowing water to flow through tube (2) and out through float valve (1) into the bucket.

The float valve is positioned in the device relative to the bucket attachment point such that the valve shuts off the water flow when the desired level of water is reached. Before the device is removed from the bucket, the shutoff valve (3) must be closed to prevent the water flow from restarting. The device is then carried to the next container and the procedure is repeated.

It should be noted that this device is useful even if only one bucket, trough or other container is to be filled since it allows an individual to fill the bucket unattended, allowing other tasks to be performed without concern for an overflow and flooding. It also allows the device to be easily removed from the bucket, avoiding damage from animals drinking from the water, in contrast to other devices, which are permanently installed in animal watering troughs.

We claim:

1. A device for filling water buckets, troughs and other containers with automatic shutoff at a predetermined water level.

2. A device as in claim 1. which is easily transported between multiple buckets, troughs and other containers.

3. A device as in claim 2. that can be left unattended while in the process of filling a bucket, trough or other container.
